(19) United States
(12) Patent Application Publication
(10) Pub. No.: US 2011/0106808 A1
(43) Pub. Date: May 5, 2011

(54) MULTI-DIMENSIONAL CONTENT ORGANIZATION AND DELIVERY

(75) Inventors: Alexandre Hersans, San Francisco, CA (US); Mark Fischer, Ashland, OR (US); Orjan Kjellberg, Walnut Creek, CA (US); Oliver Pin, Piedmont, CA (US); Sonali Agrawal, San Carlos, CA (US); Walter Macklem, San Francisco, CA (US)

(73) Assignee: salesforce.com, Inc., San Francisco, CA (US)

(21) Appl. No.: 12/857,364

(22) Filed: Aug. 16, 2010

Related U.S. Application Data
(60) Provisional application No. 61/256,858, filed on Oct. 30, 2009.

(51) Int. Cl. G06F 17/30

(52) U.S. Cl. 707/740; 707/E17.09

(57) ABSTRACT

The present disclosure provides novel systems and methods for providing multi-dimensional categorization within a multi-tenant database system (“MTS”). Data items in entities stored in a MTS may be categorized along one or more category dimensions. A search query may include one or more selected categories in one or more category dimensions. Categorization methodologies include multi-selection, multi-position, and combinations thereof. Users of the MTS may also be categorized along one or more category dimensions. A filter may present a subset of data items relevant to a user in accordance with their categorization.

### CROSS-REFERENCE TO RELATED APPLICATION

This application claims the benefit of the filing date of U.S. Provisional Application No. 61/256,858, filed on Oct. 30, 2009, the disclosure of which is incorporated by reference in its entirety.

### BACKGROUND

The present disclosure relates generally to database systems and more particularly to systems and methods for categorizing data in multi-tenant database systems (“MTS”).

As the Internet has grown, many different systems and techniques for organizing the explosion of information have been developed. One of the techniques is data categorization, wherein the data categories are typically conceived, maintained, and updated by the information provider who stores or hosts the information, or data, in databases. Data categorization can enable more intuitive and efficient interfaces for searching for and maintaining information as well as facilitating data analysis. At a basic level, data is categorized in a single dimension, e.g., widget company Acme may want to sort its database of customer-reported product issues by widget model. It may be more desirable, however, to provide a feature for categorizing data along multiple dimensions, e.g., widget company Acme may need to be able to analyze all customer-reported product issues along four dimensions: widget model, widget version, distribution channel, and manufacturing location. Such a feature can enable targeted analysis of any category of data, where a category can be comprised of any permutation, whether narrow or broad, of available categorization dimensions. U.S. Pat. No. 7,130,879 discloses such multi-dimensional categorization.

Like many such database features, implementation within the environment of a MTS presents novel challenges. For example, a MTS, such as the salesforce.com service, may utilize a multi-tenant architecture wherein unrelated organizations (i.e., tenants) can share database resources in a single logical database. The database entities, or tables, themselves are typically shared between tenants—each entity in the data model typically contains an organization_id column or similar column that identifies the data items associated with each tenant. All queries and data manipulation are performed in the context of a tenant filter on the organization_id column or similar column to ensure proper security and the appearance of virtual private databases. Since entities are shared, however, the provision of features like multi-dimensional categorization presents nontrivial issues. Each tenant of the MTS may have its own desired scheme of data categorization, and such categorization schemes are preferably highly customizable to meet the particular needs of each tenant.

Accordingly, it is desirable to provide systems and methods that provide for the creation, use, and maintenance of data categories that can be highly customized on a per-tenant basis in a MTS environment.

### SUMMARY

The present disclosure provides novel systems and methods for providing multi-dimensional categorization within a multi-tenant database system (“MTS”). Data items in entities stored in a MTS may be categorized along one or more category dimensions. A search query may include one or more selected categories in one or more category dimensions. Categorization methodologies include multi-selection, multi-position, and combinations thereof. Users of the MTS may also be categorized along one or more category dimensions. A filter may present a subset of data items relevant to a user in accordance with their categorization.

Some embodiments comprise retrieving one or more categories from one or more category dimensions and transmitting information identifying the one or more categories. The category dimensions are stored in the multi-tenant database system. The category dimensions that are retrieved are those which are accessible by a specified tenant.

Some embodiments comprise receiving an identification of a first category in a first category dimension, retrieving one or more data items that are categorized along the first category dimension, and transmitting information identifying the one or more data items. The one or more data items are retrieved from one or more database entities stored in a multi-tenant database system. The category dimensions are also stored in the multi-tenant database system. The category dimensions that are retrieved are those which are accessible by a specified tenant.

Some embodiments comprise a computer-readable medium encoded with instructions for performing the above-described operations and variations thereof.

Some embodiments comprise retrieving one or more categories from one or more category dimensions stored in the multi-tenant database system, transmitting information to display the one or more categories, receiving a selection of a first category in a first category dimension, receiving a selection of a second category in a second category dimension, returning one or more data items associated with at least one of the first category and the second category, wherein the one or more data items are retrieved from one or more database entities stored in the multi-tenant database system, and transmitting information identifying the one or more data items.

Reference to the remaining portions of the specification, including the drawings and claims, will realize other features and advantages of implementations. Further features and advantages of implementations, as well as the structure and operation of various embodiments, are described in detail below with respect to the accompanying drawings. In the drawings, like reference numbers indicate identical or functionally similar elements.

### BRIEF DESCRIPTION OF THE DRAWINGS

FIG. 1 is a block diagram that illustrates an overview of an exemplary system.

FIG. 2 is a block diagram that illustrates an exemplary embodiment of a multi-tenant database system.

FIG. 3 is an illustration of an exemplary table.

FIG. 4 shows a representation of three categorization dimensions.

FIG. 5 is an illustration of a categorization interface including three dimensions.

FIG. 6 is an illustration of three dimensions as used in a categorization process.

FIGS. 7(a) and (b) are an illustration of three dimensions as used in a multi-position categorization process.

FIG. 8 is an illustration of three dimensions as used in a multi-selection categorization process.

FIG. 9 is a representation of four data items categorized along two dimensions.

### DETAILED DESCRIPTION

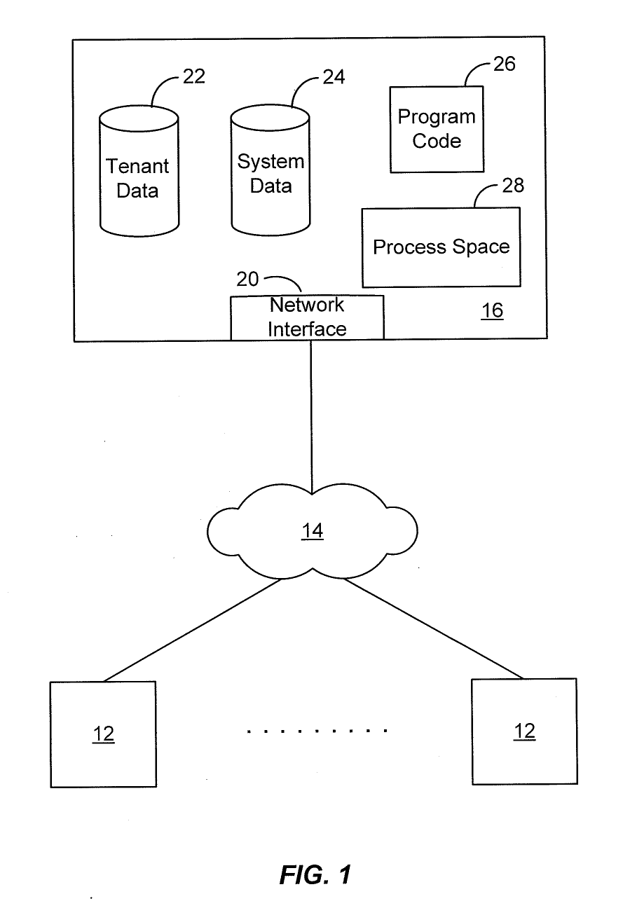

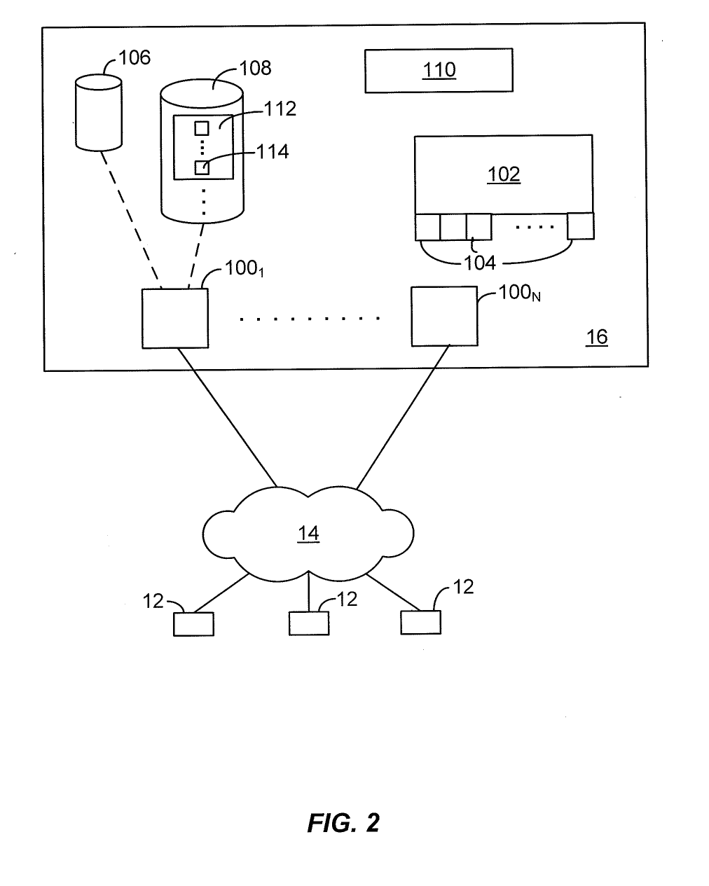

FIG. 1 illustrates an environment wherein a multi-tenant database system (“MTS”) might be used. As illustrated in FIG. 1 (and in more detail in FIG. 2) any user systems 12 might interact via a network 14 with a MTS 16. The users of those user systems 12 might be users in differing capacities and the capacity of a particular user system 12 might be entirely determined by the current user. For example, when a salesperson is using a particular user system 12 to interact with MTS 16, that user system has the capacities allotted to that salesperson. However, while an administrator is using that user system to interact with MTS 16, that user system has the capacities allotted to that administrator.

Network 14 can be a local area network (“LAN”), wide area network (“WAN”), wireless network, point-to-point network, star network, token ring network, hub network, or other configuration. As the most common type of network in current use is a Transfer Control Protocol and Internet Protocol (“TCP/IP”) network such as the global internetwork of networks often referred to as the “Internet” with a capital “I,” that will be used in many of the examples herein, but it should be understood that the networks that the system might use are not so limited, although TCP/IP is the currently preferred protocol.

User systems 12 might communicate with MTS 16 using TCP/IP and, at a higher network level, use other common Internet protocols to communicate, such as Hypertext Transfer Protocol (“HTTP”), file transfer protocol (“FTP”), Andrew File System (“AFS”), wireless application protocol (“WAP”), etc. As an example, where HTTP is used, user system 12 might include a HTTP client commonly referred to as a “browser” for sending and receiving HTTP messages from a HTTP server at MTS 16. Such a HTTP server might be implemented as the sole network interface between MTS 16 and network 14, but other techniques might be used as well or instead. In some embodiments, the interface between MTS 16 and network 14 includes load sharing functionality, such as round-robin HTTP request distributors to balance loads and distribute incoming HTTP requests evenly over a plurality of servers. Preferably, each of the plurality of servers has access to the MTS's data, at least as for the users that are accessing that server.

In aspects, the system shown in FIG. 1 implements a web-based customer relationship management (“CRM”) system. For example, in one aspect, MTS 16 can include application servers configured to implement and execute CRM software applications as well as provide related data, program code, forms, web pages and other information to and from user systems 12 and to store to, and retrieve from, a database system related data, objects and web page content. With a multi-tenant system, tenant data is preferably arranged so that data of one tenant is kept separate from that of other tenants so that one tenant does not have access to another's data, unless such data is expressly shared.

One arrangement for elements of MTS 16 is shown in FIG. 1, including a network interface 20, storage 22 for tenant data, storage 24 for system data accessible to MTS 16 and possibly multiple tenants, program code 26 for implementing various functions of MTS 16, and a process space 28 for executing MTS system processes and tenant-specific processes, such as running applications as part of an application service.

Some elements in the system shown in FIG. 1 include conventional, well-known elements that need not be explained in detail here. For example, each user system 12 could include a desktop personal computer, workstation, laptop, personal digital assistant (“PDA”), cell phone, or any WAP-enabled device or any other computing device capable of interfacing directly or indirectly to the Internet or other network connection. User system 12 typically runs a HTTP client, e.g., a browsing program, such as Microsoft's Internet Explorer® browser, Mozilla's Firefox® browser, Netscape's Navigator® browser, Apple's Safari® browser, the Opera© browser, or a WAP-enabled browser in the case of a cell phone, PDA, or other wireless device, or the like, allowing a user (e.g., subscriber of a CRM system) of user system 12 to access, process and view information and pages available to it from MTS 16 over network 14. Each user system 12 also typically includes one or more user interface devices, such as a keyboard, a mouse, touch screen, pen or the like, for interacting with a graphical user interface (“GUI”) provided by the browser on a display (e.g., monitor screen, LCD display, etc.) in conjunction with pages, forms and other information provided by MTS 16 or other systems or servers. As discussed above, the system is suitable for use with the Internet, which refers to a specific global internetwork of networks. However, it should be understood that other networks can be used instead of the Internet, such as an intranet, an extranet, a virtual private network (“VPN”), a non-TCP/IP-based network, any LAN or WAN or the like.

According to one embodiment, each user system 12 and all of its components are operator configurable using applications, such as a browser, including program code run using a central processing unit such as an Intel Pentium® processor or the like. Similarly, MTS 16 (and additional instances of MTS's, where more than one is present) and all of their components might be operator configurable using application(s) including program code run using a central processing unit such as an Intel Pentium® processor or the like, or multiple processor units. Program code for operating and configuring MTS 16 to intercommunicate and to process web pages and other data and media content as described herein is preferably downloaded and stored on a hard disk, but the entire program code, or portions thereof, may also be stored in any other volatile or non-volatile memory medium or device as is well known, such as a ROM or RAM, or provided on any media capable of storing program code, such as a compact disk (“CD”) medium, digital versatile disk (“DVD”) medium, a floppy disk, and the like. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, WAP, Ethernet, etc.) as are well known. It will also be appreciated that program code for implementing aspects of the system can be implemented in any programming language that can be executed on a server or server system such as, for example, in C, C++, HTML, Java, JavaScript, WML, any other scripting language, such as VBScript and many other programming languages as are well known.

It should also be understood that each user system 12 may include differing elements, For example, one user system 12 might include a user's personal workstation running Microsoft's Internet Explorer® browser while connected to MTS 16 by VPN, another user system 12 might include a thin-client netbook (e.g., Asus Eee PC®) running the Opera© browser while connected to MTS 16 through an extranet, and another user system 12 might include a PDA running a WAP-enabled browser while connected to MTS 16 over third-party cellular networks.

According to one embodiment, each MTS 16 is configured to provide web pages, forms, data and media content to user systems 12 to support the access by user systems 12 as tenants of MTS 16. As such, MTS 16 provides security mechanisms to keep each tenant's data separate unless the data is shared. If more than one MTS 16 is used, they may be located in close proximity to one another (e.g., in a server farm located in a single building or campus), or they may be distributed at locations remote from one another (e.g., one or more servers located in city A and one or more servers located in city B). As used herein, each MTS 16 could include one or more logically and/or physically connected servers distributed locally or across one or more geographic locations. Additionally, the term “server” is meant to include a computer system, including processing hardware and process space(s), and an associated storage system and database application (e.g., relational database management system (“RDBMS”)), as is well known in the art. It should also be understood that “server system” and “server” are often used interchangeably herein. Similarly, the databases described herein can be implemented as single databases, a distributed database, a collection of distributed databases, a database with redundant online or offline backups or other redundancies, etc., and might include a distributed database or storage network and associated processing intelligence.

FIG. 2 illustrates elements of MTS 16 and various interconnections in an exemplary embodiment. In this example, the network interface is implemented as one or more HTTP application servers 100. Also shown is system process space 102 including individual tenant process space(s) 104, a system database 106, tenant database(s) 108, and a tenant management process space 110. Tenant database 108 might be divided into individual tenant storage areas 112, which can be either a physical arrangement or a logical arrangement. Within each tenant storage area 112, a user storage 114 might similarly be allocated for each user.

It should also be understood that each application server 100 may be communicably coupled to database systems, e.g., system database 106 and tenant database(s) 108, via a different network connection. For example, one application server 100₁ might be coupled via the Internet 14, another application server 100_{N-1} might be coupled via a direct network link, and another application server 100_{N} might be coupled by yet a different network connection. TCP/IP is the currently preferred protocol for communicating between application servers 100 and the database system, however, it will be apparent to one skilled in the art that other transport protocols may be used to optimize the system depending on the network interconnect used.

In aspects, each application server 100 is configured to handle requests for any user/organization. Because it is desirable to be able to add and remove application servers from the server pool at any time for any reason, there is preferably no server affinity for a user and/or organization to a specific application server 100. In one embodiment, therefore, an interface system (not shown) implementing a load-balancing function (e.g., an F5 Big-IP load balancer) is communicably coupled between the application servers 100 and the user systems 30 to distribute requests to the application servers 100. In one aspect, the load balancer uses a least connections algorithm to route user requests to the application servers 100. Other examples of load-balancing algorithms, such as round robin and observed response time, also can be used. For example, in certain aspects, three consecutive requests from the same user could hit three different servers, and three requests from different users could hit the same server. In this manner, MTS 16 is multi-tenant, wherein MTS 16 handles storage of different objects and data across disparate users and organizations.

As an example of storage, one tenant might be a company that employs a sales force where each user (e.g., a salesperson) uses MTS 16 to manage their sales process. Thus, a user might maintain contact data, leads data, customer follow-up data, performance data, goals and progress data, etc., all applicable to that user's personal sales process (e.g., in tenant database 108). In one MTS arrangement, since all of this data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's sales data might be separate from other users' sales data regardless of the employers of each user, some data might be organization-wide data shared or accessible by a plurality of users or all of the sales force for a given organization that is a tenant. Thus, there might be some data structures managed by MTS 16 that are allocated at the tenant level while other data structures might be managed at the user level. Because an MTS might support multiple tenants including possible competitors, the MTS, in one implementation, has security protocols that keep data, applications, and application use separate. Also, because many tenants will opt for access to an MTS rather than maintain their own system, redundancy, up-time and backup are more critical functions and need to be implemented in the MTS.

In addition to user-specific data and tenant-specific data, MTS 16 might also maintain system-level data usable by multiple tenants or other data. Such system-level data might include industry reports, news, postings, and the like that are sharable among tenants.

In certain aspects, user systems 30 communicate with application servers 100 to request and update system-level and tenant-level data from MTS 16; this may require one or more queries to system database 106 and/or tenant database 108. MTS 16 (e.g., an application server 100 in MTS 16) automatically generates one or more SQL statements (a SQL query) designed to access the desired information.

Each database can generally be viewed as a collection of objects, such as a set of logical tables, containing data fitted into predefined categories. A “table,” one representation of a data object, is used herein to simplify the conceptual description of objects and custom objects in the present disclosure. It should be understood that “table” and “object” and “entity” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided. For CRM database applications, such standard entities might include tables for Account, Contact, Lead and Opportunity data, each containing pre-defined fields.

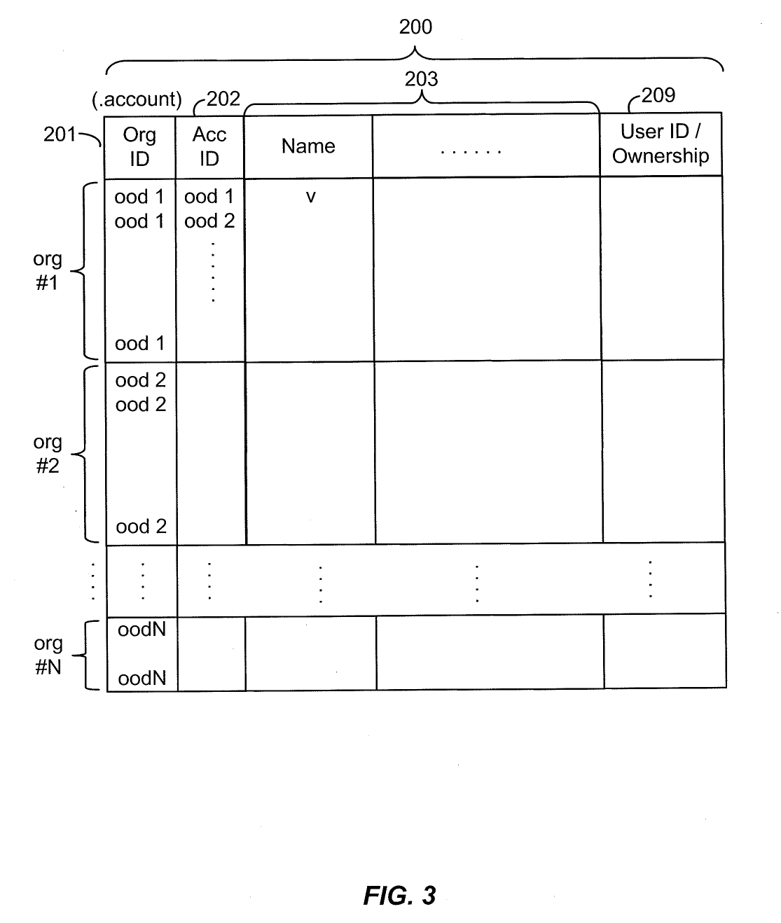

FIG. 3 illustrates an example of an object represented as a main table 200 that holds data items for multiple tenants. In the particular example shown in FIG. 3, the main table 200 (.account) represents a standard Account entity that holds account information for multiple organizations. As shown, main table 200 includes an organization ID column 201 and an account ID column 202 that acts as the primary key for main table 200. Main table 200 also includes a plurality of data columns 203 containing other information about each row. Main table 200 may also include column 209 that stores the user ID of the user that owns or created the specific account that is stored in that row.

The organization ID column 201 is provided to distinguish among organizations using the MTS. As shown, N different organizations have data stored in main table 200. In an exemplary embodiment, the organization IDs in column 201 are defined as Char(15), but may be defined as other data types. In one embodiment, the first 3 characters of the organization ID is set to a predefined prefix, such as “00d”, although another subset of characters in the organization ID may be used to hold such a prefix if desired.

In the particular example of FIG. 3, where the table represents a standard entity, data columns 203 are predefined data columns, or standard fields, that are provided to the various organizations that might use the table. In the Account entity example described above, such standard fields might include a name column, a site column, a number of employees column and others as would be useful for storing account-related information. Each of the data columns 203 is preferably defined to store a single data type per column.

U.S. patent application Ser. No. 10/817,161 filed Apr. 2, 2004, entitled “CUSTOM ENTITIES AND FIELDS IN A MULTI-TENANT DATABASE SYSTEM,” the entire disclosure of which is incorporated by reference for all purposes, discloses additional features and aspects of entities and fields in a multi-tenant database environment.

### Category Dimensions

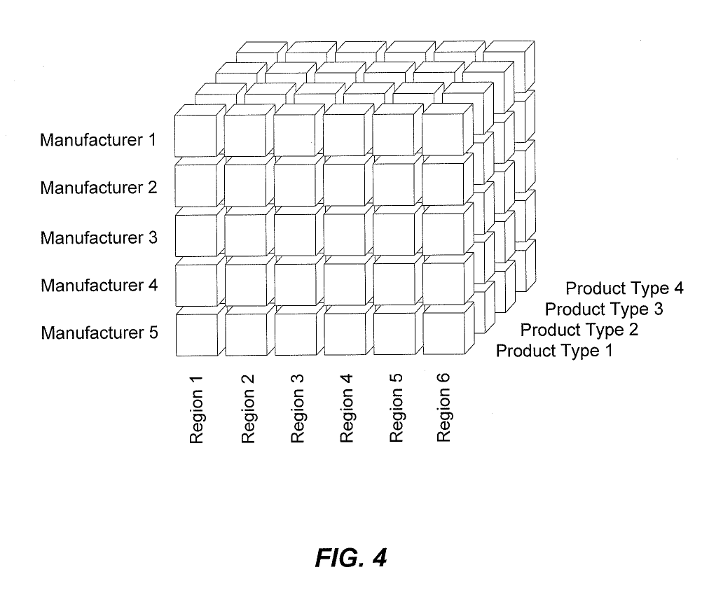

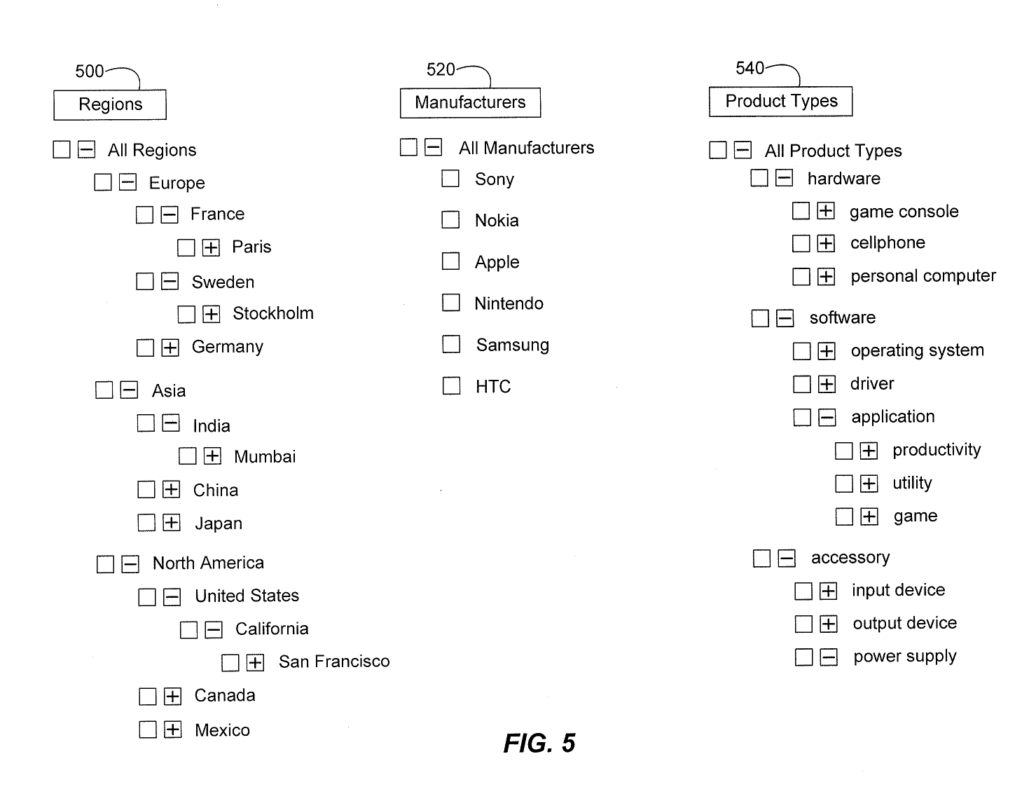

According to one embodiment, a categorization methodology provides for multi-dimensional categorization. FIG. 4 illustrates the conceptual interaction between three different category dimensions (a.k.a. data category groups): Manufacturers, Regions, and Product Types. Category dimensions can be used to categorize data items in the system, e.g., a data item in one or more of the various entities or objects stored in the multi-tenant database system. A category may be a hierarchical tree-type data structure, wherein data can be categorized using different nodes in the tree. In some embodiments, data items are only categorized at the leaf nodes of the tree. In some embodiments, data items may be categorized at any node in the tree. And in some embodiments, data items may be categorized starting at a designated level in the hierarchy or at any child node located at any level below the designated level. A category may also be a flat (non-hierarchical) data structure. In one embodiment, the user can explicitly declare whether the category dimension is flat (e.g., rendered as a standard picklist/drop-down menu) or hierarchical. This setting can be used to optimize the query to handle filters against flat (or nearly flat) categories more efficiently, since all (or most) nodes will be at the same level. Multi-dimensional categorization allows users to categorize data items into multiple category groups; conceptually, data can be categorized along multiple category dimensions (i.e., different axes), as in FIG. 5. The category dimensions are named and populated by a user, e.g., a user with administrator-level access, to reflect how they want to categorize their data within a particular entity.

Category dimensions advantageously allow for more specific searches on objects or entities by limiting searches to data items associated with categories of interest. In one embodiment, a search may include data items categorized under certain categories; such search results may be produced by using the categories as a filter or as part of the search criteria. In one embodiment, data items are filtered for different users, using user category dimensions, e.g., articles categorized for administrative users may not be shown to non-administrative users.

According to one embodiment, a categorization methodology provides tenant-specific, customizable category dimensions; standard category dimensions may also be used across multiple tenants. A tenant organization using an MTS can create and use their own category dimensions, each containing a number of categories, to categorize their data, e.g., data items in one or more of the various shared entities or objects stored in a MTS. Tenants can also categorize a single data item in multiple ways, along different category dimensions. The categories in a custom category dimension may be named, populated, and maintained by a user of a tenant organization (e.g., a user with administrator-level access) to reflect how they want to categorize their data items within a particular entity.

FIG. 5 shows a representation of three category dimensions, or data category groups, as it might be rendered on a screen. Category dimensions Regions 500, Manufacturers 520, and Product Types 540 include related individual data categories and sub-categories. A user can select data categories within any of the three dimensions by checking the boxes next to the names of the data categories. In some embodiments, a category dimension may be hierarchical, e.g., Regions 500 and Product Types 540, or flat (or nearly so), e.g., Manufacturers 520. A user may explicitly designate the category dimension as flat (visually rendered as a standard picklist/drop-down menu) or hierarchical (visually rendered with expandable controls representing one or more nodes). This designation can be used to optimize the query to handle filters against flat (or nearly flat) data category groups more efficiently, e.g., by use of conventional database indexes or custom blow-out tables. A blowout table is a data structure for materializing the transitive closure of all categories in a category group. For a given category in the category group, there may be a row in the blow-out table for each of its parent and child categories. Row information may include the “from node” (which is the current category), the “to node” (which is the parent or child category), and the “level” (which is the distance separating the two categories in the hierarchy).

U.S. Pat. No. 7,130,879, filed May 22, 2000, entitled “SYSTEM FOR PUBLISHING, ORGANIZING, ACCESSING AND DISTRIBUTING INFORMATION IN A COMPUTER NETWORK,” the entire disclosure of which is incorporated by reference for all purposes, discloses additional features and aspects of categorization and category dimensions.

### Categorization Process Example

First, administrators define a plurality of category dimensions in the system. In an exemplary embodiment, DataCategoryGroup and DataCategory entities are created to support multi-dimensional categorization. There may be one or more DataCategoryGroup entities for each tenant. A category dimension is represented as a DataCategoryGroup entity, which has either a single tree structure where each node is a category instance or a flat list of category instances. A category dimension may have different configuration settings, e.g., organization_id, name, description, creation_date, last_modified_date, flag_flat_category. The category instances that make up the hierarchy (or flat list) for a category dimension are represented as new DataCategory entities, which are child entities of a DataCategoryGroup entity. A category may have different configuration settings, e.g., parent_id, num_child_nodes, name, description, creation_date, last_modified_date. When a category is deleted, all its child categories are also deleted. Some embodiments may include standard category dimensions, such as Geography, Industry, Product Type, Service Type, etc. An example standard Geography category dimension may represent continents or sales regions covering multiple countries at the top level, each of which include subcategories broken down by country, state, province, county, city, etc. An example standard Industry category dimension may represent a hierarchical set of product categories (e.g., top level categories may include Goods and Services; subcategories of the Services category may include Advertising, Financial, Entertainment, Health Care, Hospitality, Information Technology, Legal, Publishing, Transportation, etc.).

In one embodiment, a first profile administration permission flag (e.g., “ViewDataCategories”) can be defined to enable administrators to view data categories and their underlying tree structure in the setup. A second profile administration permission flag (e.g., “ManageDataCategories”) can be defined to allow administrators to manage the data category groups and their underlying tree structure in the setup.

Administrators then populate the category dimensions, or category groups, with categories, e.g., in a hierarchical fashion. In one embodiment, category dimensions and the categories within them can be localized (e.g., modified to conform to local language and conventions).

Administrators may associate a given entity with a subset of these category dimensions, e.g., the ones that are relevant for the given entity. For example, a category dimension “Distribution Channels” may be relevant where the entity relates to tangible products, but it may not be relevant where the entity relates to online services. Such an association may be stored as one of the configuration settings for the category dimension, or it may be stored in a dedicated entity.

During the creation of a data item for the given entity, the creator can set the relevant categories in each category dimension associated with the given entity for his data item, e.g., using a picklist/drop-down menu of available categories.

When an end user enters a search query for data items in the given entity, the end user can narrow the search by providing filter criteria in the form of category selections. Data items matching the given criteria will be retrieved, according to the appropriate methodology (e.g., multi-selection, multi-position).

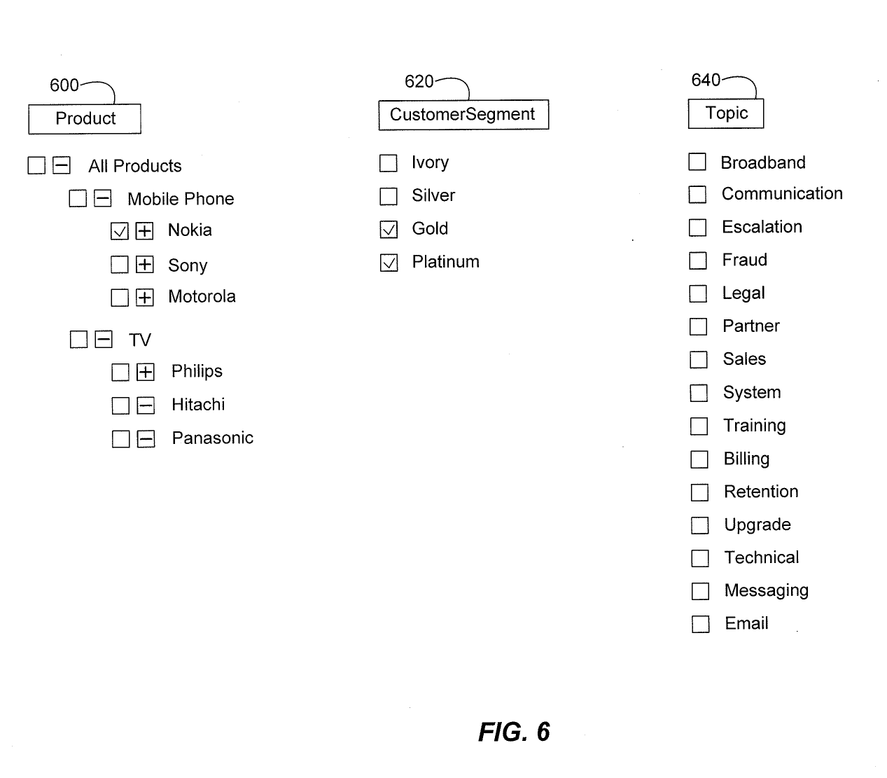

FIG. 6 is an exemplary illustration of the lifecycle of a category dimension. In this example, administrators create three category dimensions, or category groups: Product, Topic, and CustomerSegment. The category dimensions are then populated with categories. Administrators also create a new custom object called Offer in the call center application. They decide to associate the Product and CustomerSegment category dimensions to the Offer entity.

A user creates a new offer, called “Christmas gold offer” for the platinum and gold clients having a Nokia phone. As seen in FIG. 6, when setting the categorization of the offer, the user will select Nokia in the Product category dimension, and Gold and Platinum in the CustomerSegment category dimension.

In the call center, an agent receives a call from a gold client who has a Nokia phone and who wants to change his contract. The agent accesses the call center's data in the MTS and uses the classification to retrieve available offers for gold customers on Nokia phones. Among the offers, the one called “Christmas gold offer” will be retrieved.

### “Categorize-Able” Entities

According to one embodiment, an administrator or other user can enable an entity for categorization (e.g., by adding an attribute or checkbox on a custom entity), whereupon a relationship can be defined between an entity and a category dimension. In some embodiments, an association entity represents the selection of a category instance for an entity-dimension relationship (e.g., CustomObjectCategorySelection). In some embodiments, the relationship is defined by creating a foreign key (“FK”) field in the entity itself, wherein the FK is associated with a category dimension. Additional fields may also be added to the entity to select configuration settings. In one embodiment, a configuration setting restricts categorization to a single category selection or allows selection of multiple categories. In one embodiment, a configuration setting enforces a requirement that data items in the entity be categorized. In one embodiment, a configuration setting restricts category selections to only leaf nodes of a hierarchical category dimension. An entity may be categorized on multiple category dimensions by creating an entity-dimension relationship for each of them. For an instance of the categorizable entity, the values that are selected for an entity-dimension relationship can be deemed to be the categorization for that specific category dimension.

### Multi-Position and Multi-Selection

An entity may be categorized in different category dimensions, e.g., an article may be categorized in the Manufacturers category dimension and in the Regions category dimension. In one embodiment, an entity may also be categorized under multiple categories within each category dimension, e.g., both Nokia and Sony in Manufacturers 520. In one embodiment, an entity may be categorized under multiple categories that are at different levels of a hierarchical category dimension, e.g., Germany and Paris in Regions 500. When multiple categories of multiple category dimensions are selected, there are at least two different methods of applying and interpreting the categorizations: multi-selection and multi-position.

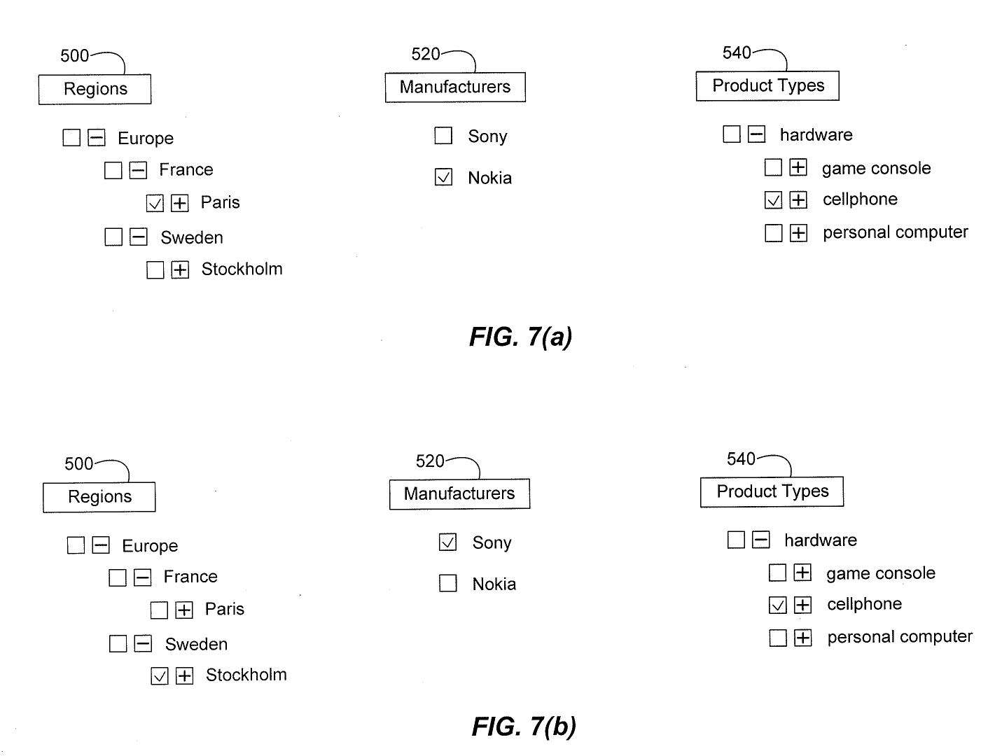

FIGS. 7(a) and 7(b) illustrate multi-position categorization. In a multi-position context, categorization selections are stored as coordinates of category dimensions. In an exemplary embodiment, each set of coordinates includes a single selected category for each category dimension (e.g., in FIG. 7(a), “Paris,” “Nokia,” and “cellphone”), and successive categorizations are stored as additional sets of coordinates (e.g., in FIG. 7(b), “Stockholm,” “Sony,” and “cellphone”). Any search for a data item must include the precise category selection in at least one category dimension. For example, search results or filtered results will include the categorized data item where the search string or filter includes the exact search terms for any category dimensions for which a selection is made: either (1) “Nokia,” “Paris,” and “cellphone,” or (2) “Sony,” “Stockholm,” and “cellphone.” In this example, a search for “Nokia,” “Stockholm,” and “cellphone” will not return the categorized data item in the search results. However, if no category is selected for one or more category dimensions, those category dimensions will not be taken into account—for example, a search for “cellphone” will return the same records as searches using the search terms listed above.

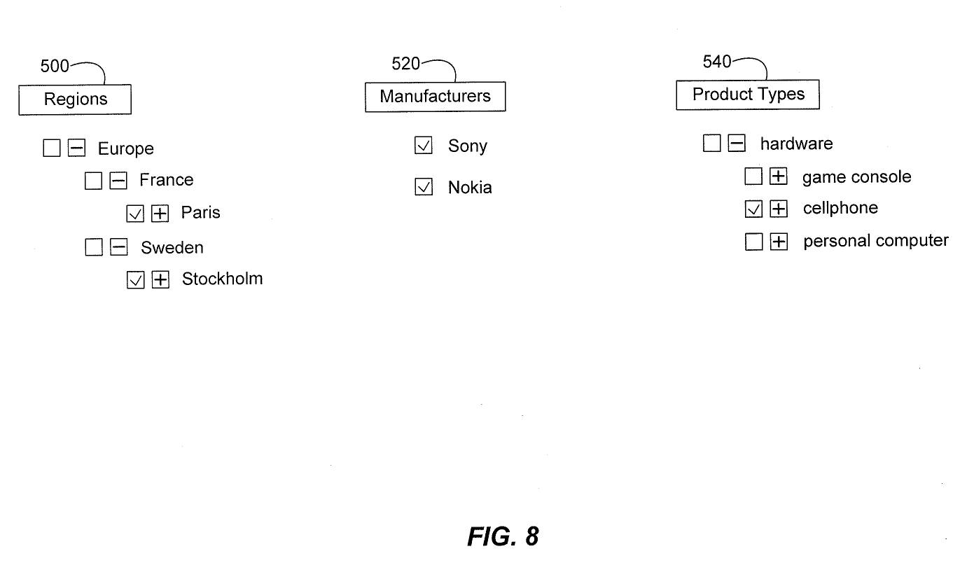

FIG. 8 illustrates multi-selection categorization. In a multi-selection context, all combinations between each category in each category dimension are included. Each time the data item is categorized, the data item will be associated with all permutations of the selected categories in each dimension; any search for the data item need only include one selected category from each dimension. In the example in FIG. 8, the data item will be returned in any of the following four searches: (1) “Nokia,” “Paris,” and “cellphone,” or (2) “Nokia,” “Stockholm,” and “cellphone,” or (3) “Sony,” “Paris,” and “cellphone,” or (4) “Sony,” “Stockholm,” and “cellphone.” And as in multi-position categorization, if no category is selected for one or more category dimensions, those category dimensions will not be taken into account, so a search for “Nokia,” “cellphone,” or even just a search for “cellphone” will return the data item.

Successive categorizations are added to the overall set of multi-selections. In the example, when the data item has already been first categorized under the combination of “Nokia” and “Paris,” and then categorized under the combination of “Sony” and “Stockholm,” it would be redundant to categorize the data item under the combination of “Sony” and “Paris,” or under the combination of “Nokia” and “Stockholm.” In some embodiments, a user can de-select specific categorizations to refine the multi-selection.

In some embodiments, when a user selects a category at an intermediary node (neither leaf node nor root node) in a hierarchical category dimension, the user can explicitly select a subset of nodes that are related to the intermediary node (e.g., all child nodes, or all nodes at level N and above, or all nodes at level N and below, where N is an arbitrary level of the hierarchy selected by the user).

In some embodiments, a user can select multiple levels of a hierarchy of categorized data items at once. In the example illustrated by Regions 500 from FIG. 5, a user may be able to select just the data items categorized precisely at the level of the “United States” category without including data items categorized at a level below or above (e.g., excluding parent, child, and sibling categories) that category. In one example, a user may be able to select just data items categorized at or below the level of the “United States” category without including data items categorized at a level above (e.g., excluding “North America” and “All Regions”) that category. In one example, a user may be able to select just data items categorized at or above the level of the “United States” category without including data items categorized at a level below (e.g., excluding “California” and “San Francisco”) that category. In one example, a user may be able to select all data items categorized at, above, or below the level of the “United States” category without including data items categorized in sibling categories (e.g., excluding “Canada” and “Europe”) that category.

### Category-Based Filters

A category-based filter can be used to restrict display of data items of the entity that are displayed to a more selective group (e.g., sidebar filter). When filtering on a category group that is hierarchical, it is possible to specify the following options for the filter:
A specific category object (at)
A specific category object and its child category objects (below)
A specific category object and its parent category objects (above)
A specific category object and its parent and child category objects (within)

In one embodiment, if more than one category group filter is defined for the entity, the filters can be combined; in this situation, only those entity objects that satisfy all filters will be displayed. The filter for a category group can also have multiple category selections. In multi-selection categorization mode, the filter would be satisfied for entity objects where the field matches at least one of the specified categories in the filter.

### Data Model Example

In one embodiment, the data model includes the following 3 tables:

CORE.CATEGORY_DATA (organization_id, entity_id,
entity_key_prefix, category_group_id, category_id) -
indexed on (organization_id, entity_key_prefix,
category_id, entity_id)

This table stores the category selections across the defined category groups.

CORE.CATEGORY_BLOWOUT (organization_id, category_group_id,
category_id, related_category_id, is_transitive) - indexed on
(organization_id, category_id, is_transitive, related_category_id)
Note:
is_transitive = is a tri-state value so as to get “at + parents” quickly.

For each category in the category group, this table stores a row for each of its parent and child categories.

CORE.SFDC_STAT (organization_id, parent_id, stat_type, stat_value,
key_prefix) Data is added to this existing table for the number of articles
(and other categorizable entities) that can potentially be viewed from
a given location: parent_id = category_id, stat_value = <count>,
key_prefix = <article>, stat_type= <operator:
at, above, below, above_or_below>.
CORE.CATEGORY_NODE (category_id, category_group_id,
name, label, parent_id)
CORE.CATEGORY_GROUP (category_group_id, name, label)
CORE.ENTITY_CATEGORY_GROUP (category_group_id, entity_id)

### Query Generation Example

By way of example, an article (i.e., data item) has been categorized along the two category dimensions in FIG. 6: Product and CustomerSegment. The user is searching for data items categorized under “Mobile Phone” and under “Gold.” Assuming that, statistically, either (1) neither the Mobile Phone category nor the Gold category makes for a particularly selective filter, or (2) they're both equally selective, an example query might be formed as below:

```
SELECT /*+ ordered use_hash(d2) use_nl(data) */ <data cols>
FROM
      (SELECT /*+ ordered use_nl(s) no_merge */ distinct s.entity_id
      FROM core.category_blowout b, core.category_data
      WHERE b.organization_id = :org AND
      b.category_id = :MobilePhones
      AND s.organization_id = :org AND s.entity_key_prefix =
:Article AND s.category_id = b.related_category_id) d1,
      (SELECT /*+ ordered use_nl(s) no_merge */ distinct s.entity_id
      FROM core.category_blowout b, core.category_data
      WHERE b.organization_id = :org AND b.category_id = :Gold
      AND s.organization_id = :org AND s.entity_key_prefix =
:Article AND s.category_id = b.related_category_id) d2,
      core.article data
WHERE d1.entity_id = d2.entity_id
AND data.org_id = :org
AND data.article_id = d1.entity_id;
```

In one embodiment, if one of two selected categories were a highly selective filter, the query would start with its category dimension and then go through a nested loop to filter along the other category dimension.

It is useful to capture the right statistics at the right level of granularity, and to maintain the right model, so intelligent decisions to optimize the query can be made without creating an unmanageable quantity of data to store. Accordingly, in one embodiment, certain limits may be put in place:
Max # category groups/entity (e.g., default 4)
Max category hierarchy depth (e.g., default 5)
Total category items within the hierarchy (e.g., max 1000)
   For dimensions that are shared across tenants in the MTS, in one embodiment, these types of limits are stored as tenant-specific values so that they can be modified accordingly.

In order to make intelligent decisions on how to construct the most efficient queries for filtering data, it may be useful to make available (e.g., at run-time) certain statistics about the data tables. Since these tables are being constantly updated, the statistics are ideally re-computed on a regular basis. Useful statistics may include:

1. The number of records for an entity that have been categorized at a given category in a category group.
2. The number of records for an entity that have been categorized at or above a given category in a hierarchical category group.
3. The number of records for an entity that have been categorized at or below a given category in a hierarchical category group.
Such statistics can be used to generate an efficient query at run-time.

### “Un-Categorize”

In one embodiment, a user can categorize a particular data item or set of data items along a particular category dimension with a blank or “not set” value (i.e., “un-categorize” the data item(s)). This means that no particular category within the category dimension has been selected for the data item(s). As applied to hierarchical category dimensions, this concept should not be confused with categorizing the data item(s) to the broadest category in the category dimension (e.g., the “All Regions” category of the Regions 500 dimension in FIG. 5).

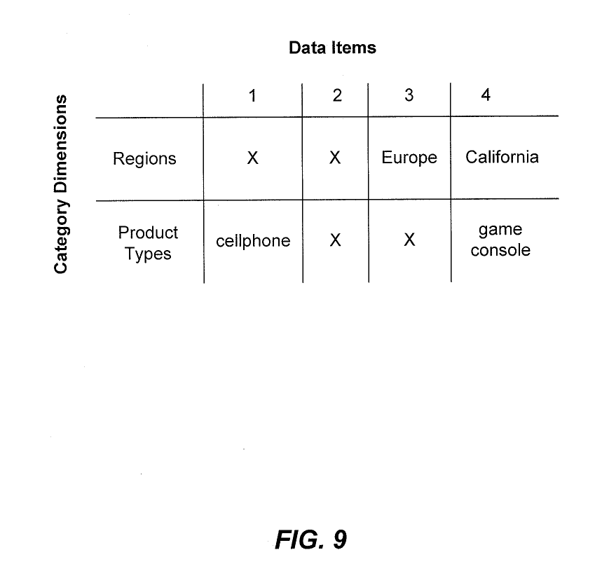

FIG. 9 shows an example including four data items that have been categorized along up to two category dimensions (“Regions” and “Product Types”). In one embodiment, if a blank value is selected for a category dimension (i.e., “not set”) when filtering, then data items that have been categorized as blank, or “not set,” for that category dimension will match. Data item 1 has been categorized in the “cellphone” category along the Product Types dimension, and its categorization is “not set” along the Regions dimension. Data item 2 has been categorized as “not set” in both dimensions. Data item 3 has been categorized in the “Europe” category along the Regions dimension, and its categorization is “not set” along the Product Types dimension. Data item 4 has been categorized in the “California” category along the Regions dimension and in the “game console” category along the Product Types dimension. If a filter is configured to “show all records,” then data items 1 through 4 will be displayed. If a filter is configured to “show records related to Europe,” then data item 3 will be displayed. If a filter is configured to “show all records related to All Regions,” then data items 3 and 4 will be displayed. If a filter is configured to “show records related to the cellphone and Europe,” then no data items will be displayed.

### Updating and Deleting Category Dimensions

In one embodiment, a user (e.g., an administrator) can update a category dimension. A category's name can be updated; in addition, entirely new categories can be inserted into a category dimension. A user can also change the parent field of a data category, thereby moving the data category and all of its child nodes to another location in the hierarchy.

In one embodiment, a user (e.g., an administrator) can delete a category dimension. If there are entities that have been associated with the category dimension, then all such associations are also deleted. If there are data items that are categorized along a category dimension that is to be deleted, then any such categorizations are removed.

In one embodiment, a user (e.g., an administrator) can delete a particular category in a category dimension. If there are data items that are categorized at the particular category that is to be deleted, then any such categorizations can be automatically handled in a few different ways: the categorizations can be removed by categorizing those data items to “not set;” the data items can be re-categorized at the parent of the particular category that is to be deleted; or the data items can be re-categorized en masse at a category of the administrator's choice. If the category dimension is hierarchical, and if the particular category to be deleted has child node(s), then any removal operations are run on the child nodes as well as the particular category to be deleted.

In addition, when the hierarchical structure of a category group is modified, it may necessitate changes in the data that is categorized in this category group. In one example, a data item in an Offer entity is categorized at the Paris category in the Geography category group. If the Paris category is deleted from the Geography category group, then one must delete all categorizations that the Offer entity had at the Paris category, which could be hundreds of thousands to millions of records that need to be modified. Such changes in the structure of a category group must therefore be handled strategically to avoid affecting other system transactions.

Once the user makes the structural changes, the metadata of the category group is modified to reflect those changes, but it may take some time for the change to reach all the underlying data items that must be re-categorized in the new category group structure. These data-level changes can be queued for batch processing, where each batch process is given a unique set of records to work on to allow for parallelization of the work. This strategy of batch processing allows for more efficient usage of system resources and avoids the problems that a synchronous, serial process could cause. In one embodiment, while these data-level changes are being made asynchronously (“in the background”), the user may be blocked from making further changes to the category group structure. Once the asynchronous work has completed, the user is once again able to change the category group structure.

### User Category Dimensions

User category dimensions provide the ability to share data items and enforce data security according to different user profiles. A user of the MTS can be associated with a user category. User categories advantageously allow for filtering and targeted searches. In one embodiment, an administrator may categorize users according to their roles and locations; such users will be allowed to see data items that have been categorized with matching user categories. In one embodiment, an administrator may categorize users and data items with appropriate user categories in order to ensure that only users with appropriate permissions or levels of authority are able to view the data items categorized with the user categories. In one embodiment, when a user is added to or removed from a particular user category dimension, the visibility of associated data items changes automatically, with respect to that user.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. For example, in one embodiment, an intermediate server or other computer provides one or more interfaces (e.g., an Application Programming Interface (“API”), a web service, an HTTP-based interface, or other conventional protocol for transmitting instructions) to a MTS in order to enable a user to perform one or more of the operations described herein. Therefore, the scope of the appended claims should be accorded the broadest interpretation so as to encompass all such modifications and similar arrangements.

What is claimed is:

1. A method for categorization in a multi-tenant database system, the method comprising:
receiving at a network interface of a server in the multi-tenant database system an identifier, wherein the identifier is associated with a tenant in the multi-tenant database system;
retrieving using a processor of the server one or more categories from one or more category dimensions stored in the multi-tenant database system based on the identifier, wherein the one or more category dimensions are accessible by the tenant; and
transmitting from the network interface information identifying the one or more categories.

2. The method of claim 1, further comprising:
receiving a definition for a category in a category dimension; and
configuring the category according to the definition, wherein the category is stored in the multi-tenant database system.

3. The method of claim 1, further comprising:
receiving an identification of a selected category dimension;
receiving an identification of a data item in an entity stored in the multi-tenant database system; and
categorizing the data item along the selected category dimension.

4. The method of claim 3, wherein the data item is categorized with a blank value for the selected category dimension.

5. A method for retrieving data in a multi-tenant database system, the method comprising:
receiving at a network interface of a server in the multi-tenant database system an identifier, wherein the identifier is associated with a tenant in the multi-tenant database system;
receiving at the network interface an identification of a first category in a first category dimension, wherein the first category dimension is accessible by the tenant;
retrieving using a processor of the server one or more data items, wherein the one or more data items are retrieved from one or more database entities stored in a multi-tenant database system, and wherein the one or more data items are categorized along the first category dimension; and
transmitting from the network interface information identifying the one or more data items.

6. The method of claim 5, further comprising:
receiving an identification of a second category in a second category dimension, wherein the second category dimension is accessible by the tenant; wherein the one or more data items are categorized along at least one of the first category dimension and the second category dimension.

7. The method of claim 6, wherein the one or more data items are categorized along both the first category dimension and the second category dimension.

8. The method of claim 5, further comprising:
retrieving data items categorized with a blank value for the first category dimension.

9. The method of claim 5, wherein the data items are categorized under one of a subset of categories that are related to the first category.

10. A method of filtering data items for a user of a multi-tenant database system, the method comprising:
receiving at a network interface of a server in the multi-tenant database system information about a user of the multi-tenant database system, wherein the user is associated with an organization that is a tenant of the multi-tenant database system, and wherein the user is categorized under a category of a category dimension;
receiving at the network interface a request for data items relevant to the user;
retrieving using a processor of the server one or more data items associated with the category, wherein the one or more data items are retrieved from entities stored in the multi-tenant database system; and
transmitting from the network interface information identifying the one or more data items.

11. A computer-readable medium containing program code executable by a processor in a computer to categorize data items in a multi-tenant database system, the program code including instructions to:
receive at a network interface of a server in the multi-tenant database system an identifier, wherein the identifier is associated with a tenant in the multi-tenant database system;
retrieve using a processor of the server one or more categories from one or more category dimensions stored in the multi-tenant database system based on the identifier, wherein the one or more category dimensions are accessible by the tenant; and
transmit from the network interface information to display the one or more categories.

12. The computer-readable medium of claim 10, the program code including further instructions to:
receive a definition for a category in a category dimension; and
configure the category according to the definition, wherein the category is stored in the multi-tenant database system.

13. The computer-readable medium of claim 10, the program code including further instructions to:
receive an identification of a selected category dimension;
receive an identification of a data item in an entity stored in the multi-tenant database system; and
categorize the data item along the selected category dimension.

14. The computer-readable medium of claim 13, wherein the data item is categorized with a blank value for the selected category dimension.

15. A computer-readable medium containing program code executable by a processor in a computer to retrieve data in a multi-tenant database system, the program code including instructions to:
receive at a network interface of a server in the multi-tenant database system an identifier, wherein the identifier is associated with a tenant in the multi-tenant database system;
receive at the network interface an identification of a first category in a first category dimension, wherein the first category dimension is accessible by the tenant;
retrieve using a processor of the server one or more data items, wherein the one or more data items are retrieved from one or more database entities stored in a multi-tenant database system, and wherein the one or more data items are categorized along the first category dimension; and
transmit from the network interface information identifying the one or more data items.

16. The computer-readable medium of claim 15, the program code including further instructions to:
receive an identification of a second category in a second category dimension, wherein the second category dimension is accessible by the tenant, wherein the one or more data items are categorized along at least one of the first category dimension and the second category dimension.

17. The computer-readable medium of claim 16, wherein the one or more data items are categorized along both the first category dimension and the second category dimension.

18. The computer-readable medium of claim 15, the program code including further instructions to:
retrieve data items categorized with a blank value for the first category dimension.

19. The computer-readable medium of claim 15, wherein the data items are categorized under one of a subset of categories that are related to the first category.

20. A computer-readable medium containing program code executable by a processor in a computer to filter data items for a user of a multi-tenant database system, the program code including instructions to:
receive at a network interface of a server in the multi-tenant database system information about a user of the multi-tenant database system, wherein the user is associated with an organization that is a tenant of the multi-tenant database system, and wherein the user is categorized under a category of a category dimension;
receive at the network interface a request for data items relevant to the user;
retrieve using a processor of the server one or more data items associated with the category, wherein the one or more data items are retrieved from entities stored in the multi-tenant database system; and
transmit from the network interface information identifying the one or more data items.

21. A computer-readable medium containing program code executable by a processor in a computer to categorize data items in a multi-tenant database system, the program code including instructions to:
receive at a network interface of a server in the multi-tenant database system an identifier, wherein the identifier is associated with a tenant in the multi-tenant database system;
retrieve using a processor of the server one or more categories from one or more category dimensions stored in the multi-tenant database system, wherein the one or more category dimensions are accessible by the tenant;
transmit from the network interface information to display the one or more categories;
receive at the network interface a selection of a first category in a first category dimension;
receive at the network interface a selection of a second category in a second category dimension;
return using the processor one or more data items associated with at least one of the first category and the second category, wherein the one or more data items are retrieved from one or more database entities stored in the multi-tenant database system; and
transmit from the network interface information identifying the one or more data items.
